(19) United States
(12) Patent Application Publication
(10) Pub. No.: US 2017/0008473 A1
(43) Pub. Date: Jan. 12, 2017

(54) BONDED LAMINATE VEHICLE GRILL STRUCTURE

(71) Applicant: David Walters, Caledonia, MI (US)

(72) Inventor: David Walters, Caledonia, MI (US)

(73) Assignee: LACKS ENTERPRISES, INC., Grand Rapids, MI (US)

(21) Appl. No.: 14/794,580

(22) Filed: Jul. 8, 2015

(51) Int. Cl. B60R 19/52

(52) U.S. Cl. CPC B60R 19/52; B60R 2019/525

(57) ABSTRACT

A grill assembly for attachment to a vehicle front end includes a grill portion having a front surface and a rear surface and a carrier portion having a front side and a rear side. The grill portion also includes a peripheral border portion and a plurality of generally horizontal grill cross-slats, which define a plurality of grill openings therebetween. The carrier portion also includes an outer perimeter and a plurality of generally horizontal cross-pieces, which define a plurality of carrier portion openings therebetween which are designed to align with the grill openings. The front surface of the grill portion includes a decorative surface disposed thereon. The front side of the carrier portion is bonded to substantially the entirety of the rear surface of the grill portion so as to form a laminate grill structure.

### TECHNICAL FIELD

The present disclosure relates generally to an improved vehicle grill construction. More specifically, the present disclosure relates to a vehicle grill with a bonded laminate construction, which, in addition to providing enhanced aesthetic characteristics, also provides structural and strength benefits.

### BACKGROUND OF THE INVENTION

Automotive vehicle front ends typically utilize grill structures with openings that serve as an air intake for receiving ambient air into the vehicle system. The air flow through the grill is utilized for operation of the vehicle, including cooling, climate control, and for mixture with fuel for a propulsion device of the vehicle, such as an internal combustion engine. The grill structures are generally part of a vehicle front end, which front end plays a prominent role in the styling and identity of a vehicle. Consequently, tremendous effort goes into the styling, design and structure of a vehicle front end, including the grill structure. In fact, vehicle grill structures are often incorporated into other front end structures to enhance aesthetics. Existing vehicle grills require a large amount of front end space.

To further enhance their aesthetic appeal, many vehicle grill structures employ a metal plated layer or other decorative features on their exterior class A surfaces, such as a chrome plated layer. As is known, a chrome plated layer generally provides a shiny appearance that is attractive and desirable for many vehicle owners. These chrome plated layers are also known to provide other benefits, including corrosion resistance and ease of cleaning. However, these metal layers can be expensive and can result in increased weight.

Accordingly, it would also be desirable to provide a vehicle grill structure that overcomes these disadvantages.

### SUMMARY OF THE INVENTION

It is therefore an aspect of the present disclosure to provide a laminate vehicle grill structure which eliminates the need for hard attachments between a grill portion and a carrier structure.

It is another aspect of the present disclosure to provide a laminate vehicle grill structure that yields improved cold impact performance.

It is a further aspect of the present disclosure to provide a laminate vehicle grill structure having less mass than prior grill structures.

It is yet another aspect of the present disclosure to provide a laminate vehicle grill structure that assists with improved vehicle fuel economy.

It is still another aspect of the present disclosure to provide a laminate vehicle grill structure that is less complex and less expensive to manufacture.

It is still yet a further aspect of the present disclosure to provide a laminate vehicle grill structure that requires less front end space than prior grill structures and provides improved packaging capabilities.

It is still yet another aspect of the present disclosure to provide a laminate vehicle grill structure that minimizes noise, vibration and harshness (NVH) issues.

It is yet a further aspect of the present disclosure to provide a laminate vehicle grill structure that provides improvements in buzz, squeak and rattle (BSR) issues.

It is still another aspect of the present disclosure to provide a vehicle grill structure having increased sectional modulus strength as compared to prior grill structures.

In accordance with the above and the other aspects of the present disclosure, a grill assembly for attachment to a vehicle front end is provided. The grill assembly includes a grill portion having a front surface and a rear surface. The grill portion includes a peripheral border portion and a plurality of generally horizontal grill cross-slats, which define a plurality of grill openings therebetween. The grill assembly also includes a carrier portion having a front side, a rear side, and an outer perimeter. The carrier portion further includes a plurality of generally horizontal cross-pieces, which define a plurality of carrier portion openings therebetween which are designed to align with the grill openings. The front surface of the grill portion and/or carrier portion includes a decorative surface disposed thereon. The front side of the carrier portion is bonded to the rear surface of the grill portion such that the bond exists over substantially the entirety of the grill portion rear surface so as to form a laminate grill structure.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a schematic illustration of a vehicle having a vehicle grill assembly in accordance with an aspect of the disclosure;

FIG. 2 is a schematic perspective exploded view of a portion of a vehicle grill assembly in accordance with an aspect of the present disclosure;

FIG. 3 is partial front and partial rear view of a carrier structure of a vehicle grill assembly along the line 3-3 in accordance with an aspect of the present disclosure;

FIG. 4 is a partial front and partial rear view of a grill portion of a vehicle grill assembly along the line 4-4 in accordance with an aspect of the present disclosure;

FIG. 5A is a schematic cross-sectional view of a vehicle grill assembly according to the prior art;

FIG. 5B is a schematic cross-sectional view of a vehicle grill assembly in accordance with an aspect of the present disclosure;

FIG. 6A is a schematic cross-sectional view of a vehicle grill assembly according to the prior art;

FIG. 6B is a schematic cross-sectional view a vehicle grill assembly in accordance with another aspect of the present disclosure;

FIG. 7 is a schematic illustration of a grill assembly in accordance with an aspect of the present disclosure;

FIG. 8 is a schematic illustration of a grill assembly in accordance with another aspect of the present disclosure; and

FIG. 9 is a schematic illustration of an adhesive pattern in accordance with an aspect of the present disclosure.

### DETAILED DESCRIPTION OF THE INVENTION

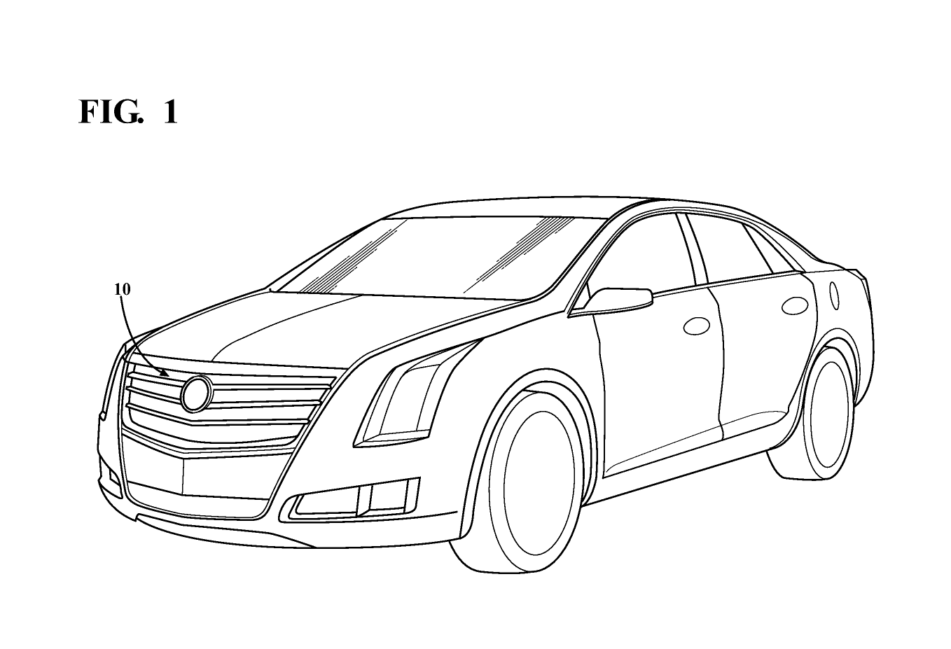

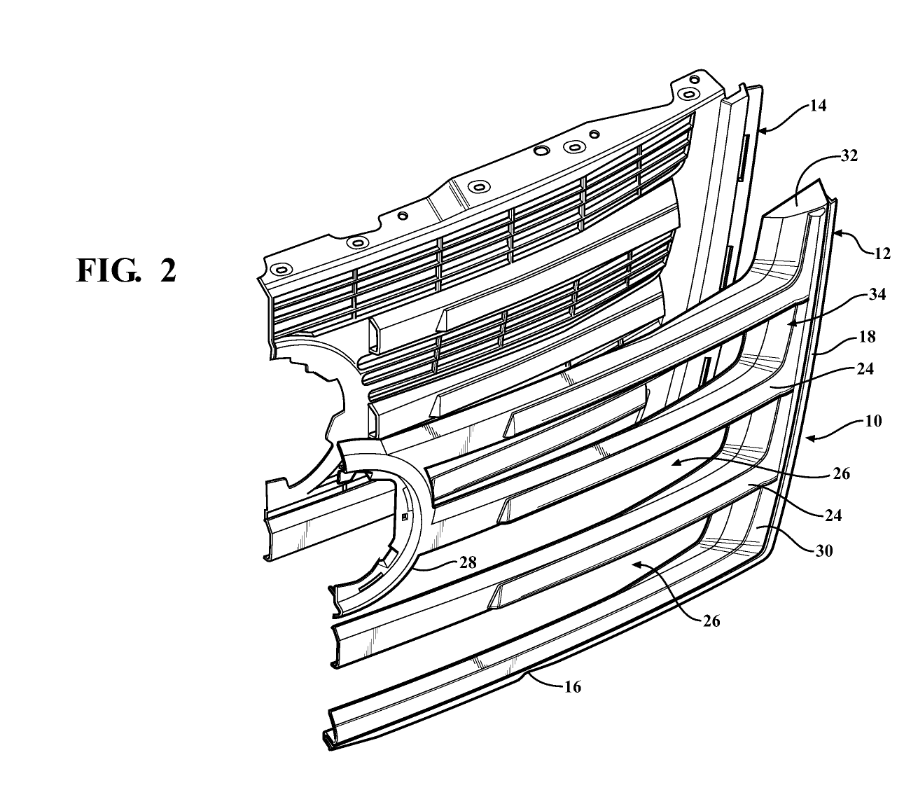

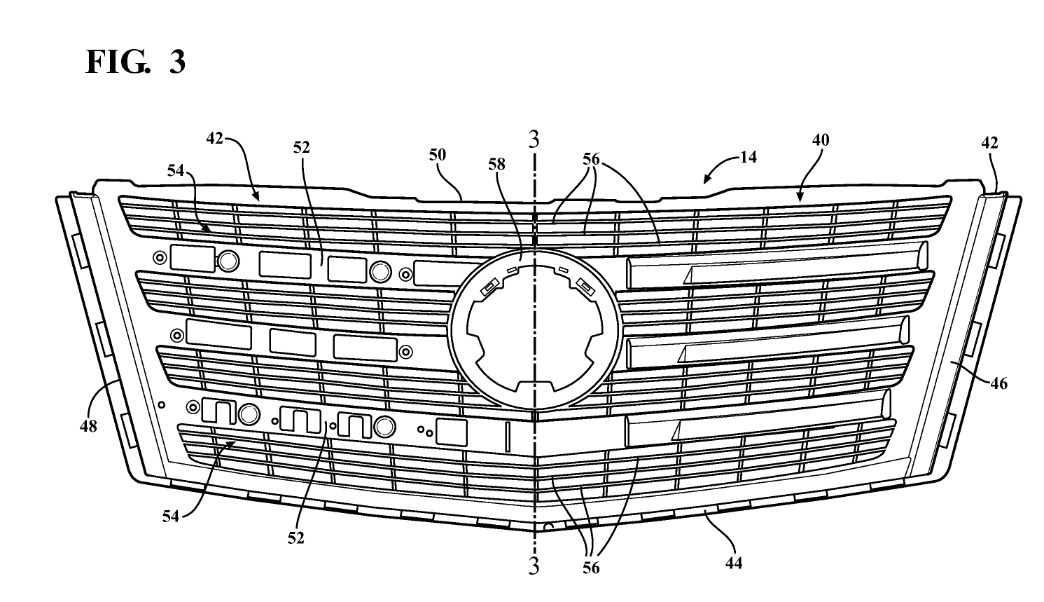

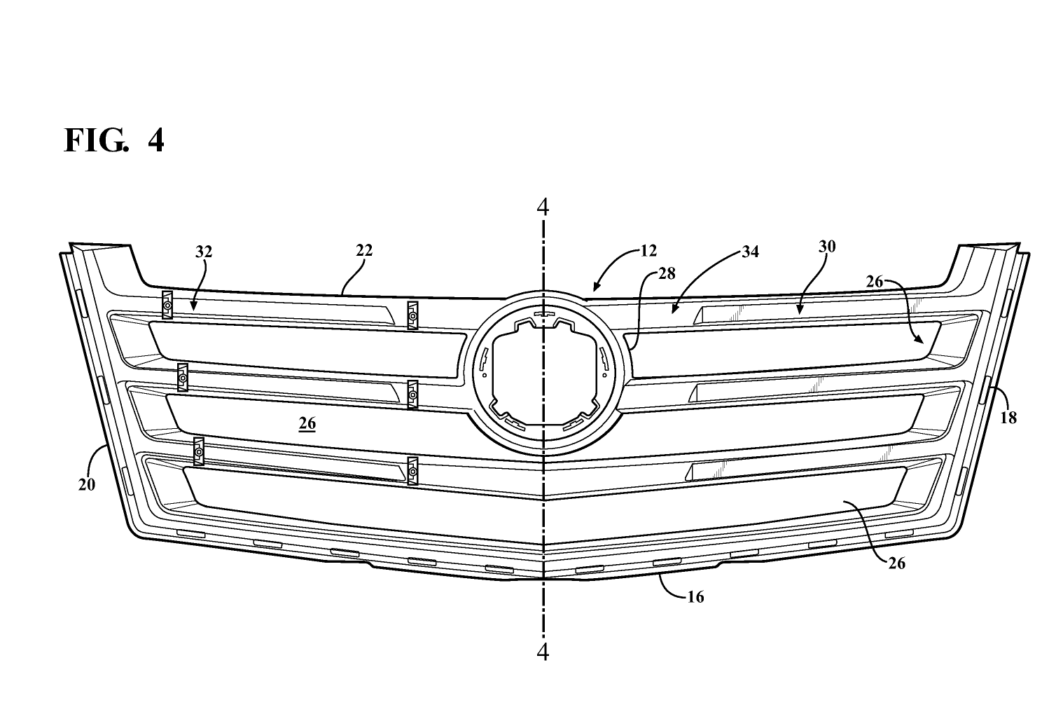

Referring now to FIGS. 1 through 4, the present disclosure relates to a vehicle grill assembly 10. According to an aspect, the vehicle grill assembly 10 includes a grill portion 12 and a carrier portion 14. As discussed herein, the grill portion 12 can be fixedly secured to the carrier portion 14 such that they form a laminate construction. According to another aspect, the grill portion 12 can be formed from a plastic material, such as through an injection molding process. It will be appreciated that the grill portion 12 could be formed from a variety of other suitable materials and/or by a variety of other suitable manufacturing processes. Similarly, the carrier portion 14 may also be formed from a plastic material, such as through an injection molding process. Again, it will also be appreciated that the carrier portion 14 can be formed from a variety of other suitable materials and/or by a variety of other manufacturing processes. For example, the carrier portion 14 can be constructed of a stronger material, such as a glass filled nylon resin. According to a further aspect, the grill assembly 10 can include more than two parts that are secured to yield a laminate construction. It will be appreciated that the number of parts can vary based on design and performance criteria.

According to an aspect, the grill portion 12 can include a bottom portion 16, a first side portion 18, a second side portion 20, and a top portion 22. The bottom portion 16, the first side portion 18, the second side portion 20, and the top portion 22 can form a contiguous outer peripheral border portion. It will also be appreciated that the outer peripheral border portion can take on a variety of shapes, including circular. According to an aspect and as shown, the grill portion 12 can also include a plurality of generally horizontal cross-bars 24 which serve to define a plurality of openings 26 that act as air inlets to allow air to be conveyed to the engine compartment as is known. The cross-bars 24 and the openings 26 can be oriented in a variety of different directions as desired. The grill portion 12 can also include a center portion 28, such as for receiving a vehicle model or manufacturer logo or emblem. The grill portion 12 can also include a front surface 30, which generally faces the direction of travel of a vehicle, and a rear surface 32 opposing the front surface 30. It will be appreciated that the grill portion 12 can have a variety of different shapes, appearances and structures as desired.

According to an aspect, the grill portion 12 can have a decorative finish 34 disposed on one or more surfaces, including at least the front surface 30. According to one aspect, the decorative finish 34 can consist of a metal layer 68 disposed thereon to provide a Class A surface with an enhanced exterior appearance. It will be appreciated that the decorative finish 34 can be present on all surfaces of the grill portion 12 or on the visible surfaces only. According to this aspect, the metal layer 68 may consist of a layer of Chromium that is plated on the front surface 30 of the grill portion 12. However, a variety of other suitable metals may be employed to form the metal layer 68, including Nickel or Copper. It will also be appreciated that the metal layer 68 may be disposed on the part surface or surfaces in a variety different suitable ways, including by an electrolytic process. It will be appreciated that a variety of other suitable processes may be employed to form the metal layer 68, including vacuum deposition. According to another aspect, the decorative finish 34 can result from a variety of other suitable methods, including by a molded-in-color process such that the part itself has a desired color, as is known in the art. Additionally, the decorative finish 34 may consist of one or more paint layers that are applied to the part. It will be appreciated that a variety of other suitable processes or techniques can be employed to yield the decorative finish 34. For example, a decorative finish 68 can be achieved with a foil-insert molded film. It will also be appreciated that the decorative finish 34 could result from any combination of the above methods or techniques.

According to an aspect, the carrier portion 14 can include a front side 40, which again faces the direction of travel of a vehicle and a rear side 42 which opposes the front side 40. The carrier portion 14 can also include a bottom portion 44, a first side portion 46, a second side portion 48, and a top portion 50 which define an outer perimeter. Again, the carrier portion 14 can take on a variety of shapes. According to a further aspect, the carrier portion 14 can include a plurality of generally horizontal cross-pieces 52 which serve to define a plurality of openings 54. The plurality of openings 54 may be configured to generally align with the grill openings 26 to permit air flow through the grill assembly 10. As shown, the carrier portion 14 can also include a plurality of cross-slats 56 disposed in each of the openings 54. The carrier portion 14 can further include a center portion 58. It will be appreciated that the carrier portion 14 can have a variety of different shapes, appearances and structures as desired. The grill assembly 10 can include other structures such as mesh to provide protection to the interior components. It will be appreciated that moveable louvers may be employed to regulate airflow through the grill assembly 10 in accordance with vehicle speed.

According to an aspect, the carrier portion 14 does not include any decorative surfaces. However, according to another aspect, where the front side 40 of the carrier portion 14 serves as a class A surface for the grill assembly 10, the carrier portion 14 can include one or more decorative surfaces, which may be formed or configured in the same manner as described above in connection with the grill portion 12. According to a further aspect, the grill portion 12 could be configured to be adhesively attached to a molded-in-color carrier portion 14, which could yield significant product differentiation options with inexpensive tooling. Put another way, the molded-in-color carrier portion 14, could have cladded portions secured to portions of the front side 40 thereof such that the cladded portions are designed for specific areas, such as the center portion to provide increased strength, while other portions of the carrier portion 14 may be exposed with the molded-in-color surface providing the decorative surface.

According to a still further aspect, the carrier portion 14 may be configured without any attachment structures for the grill portion 12, such as doghouse attachments or other fastener attachment structures. The elimination of these features allows for significantly less complex injection molding tools, which decreases the cost to manufacture, the time to manufacture, and increases the quality of the part surface, due to the elimination of structures that are known to cause sinks, undesirable flow paths and/or mold stick. Additionally, a less complex mold may be more reliable, require less maintenance thereby reducing costs and prolonging the life of the mold. According to a still further aspect, a simpler mold can allow for dramatic model changes and mid-cycle enhancements without expensive tooling changes.

According to an aspect, the grill portion 12 may be bonded to the carrier portion 14 such as by an adhesive. A variety of suitable adhesives may be utilized to secure these structures. According to a further aspect, tape can be employed to adhere the carrier portion 14 to the grill portion 12. It will be appreciated that the grill portion 12 may be bonded to the carrier portion 14 in a variety of other suitable ways. According to an aspect, the rear surface 32 of the grill portion 12 may be secured to the front side 42 of the carrier portion 14 such that substantially the entirety of the grill portion 12 rear surface 32 is bonded to and thus supported by the carrier portion 14. It will be appreciated that less than the entirety of the grill portion rear surface 32 may be bonded to the carrier portion 14. As will be appreciated, the utilization of an adhesive bond to secure the grill portion 12 to the carrier portion 14 eliminates the need for hard attachments such as doghouses for screws, studs, snaps, heat stakes and the like that would otherwise be needed.

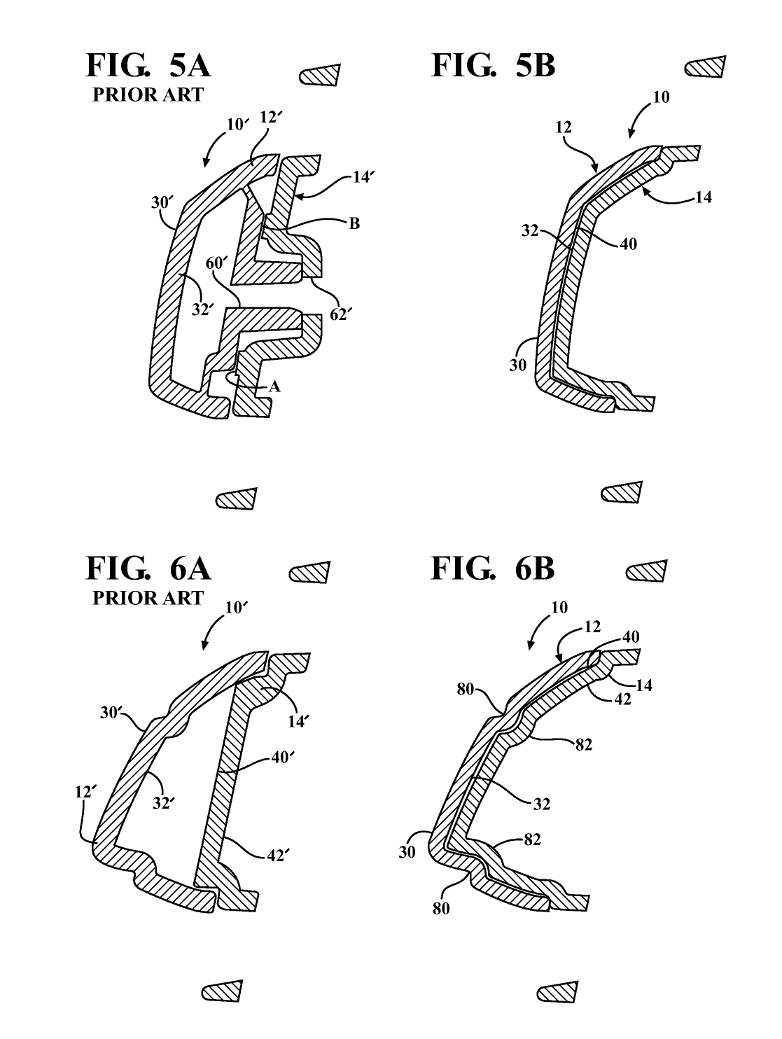

Referring now to FIGS. 5A and 5B which illustrate attachments of a grill portion 12 to a carrier portion 14. Specifically, FIG. 5A illustrates a grill assembly 10′ in accordance with the prior art. As shown, in FIG. 5A, a grill portion 12′ has a front surface 30′ that faces outward of the vehicle and a rear surface 32′ that faces inward in the direction of an engine compartment. The grill portion 12′ includes a doghouse attachment portion 60′ located rearward of the rear surface 32′ to facilitate attachment with the carrier portion 14′ by way of a mechanical fastener. As shown, the carrier portion 14′ is located behind the grill portion 12′ and is fixedly secured thereto through an opening 62′ formed therein which aligns with the doghouse portion 60′. As shown, the front side 40′ of the carrier portion 14′ can engage the doghouse attachment portion 60′ at points A and B.

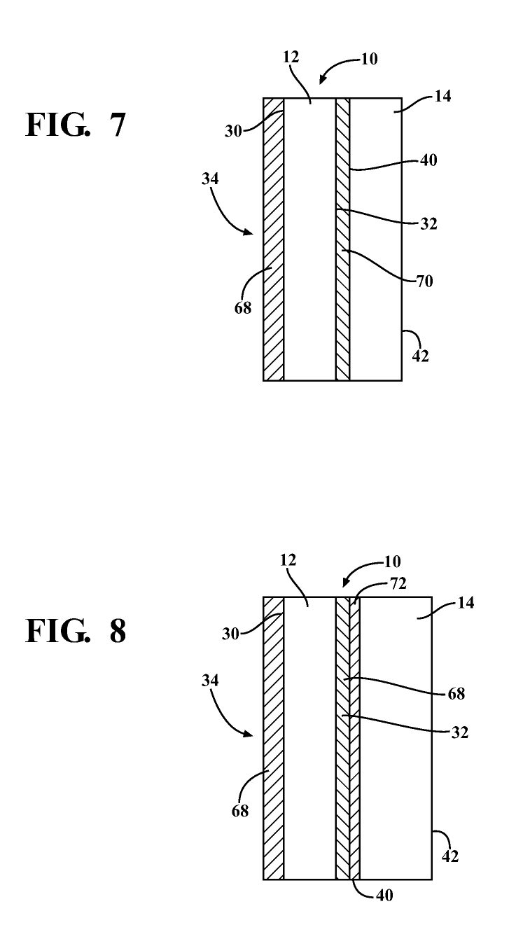

Turning now to FIG. 5B, which illustrates an attachment structure and method according to the present disclosure. As shown, the grill portion 12 does not include any doghouse attachment portion 60′. Instead, according to an aspect, the front side 40 of the carrier portion 14 can minor the rear side 32 of the grill portion 12. According to an aspect, and as schematically shown in FIG. 7, the front surface 30 of the grill portion 12 can include a decorative surface 34 in the form of a decorative metal layer 68 disposed thereon. According to a further aspect, the rear surface 32 of the grill portion 12 can have a layer of resist 70 applied thereto. The layer of resist may be disposed on the rear surface 32 of the grill portion 12 prior to application of the metal layer 68, such as by a metal plating process. The layer of resist 70 can prevent the metal layer 68 from being applied to the rear surface 32 of the grill portion 12 (or other portions where the resist layer 70 is applied) during the process of applying the metal layer 68 to the front surface of the grill portion 12.

According to a further aspect, an adhesive layer 72 can be employed between the front side 40 of the carrier portion 14 and the rear side 32 of the grill portion 12. According to an aspect, the use of the resist layer 70 on the rear side 32 of the grill portion 12 can provide for a mass reduction by reducing backside plating. The elimination of any metal plating on the rear surface 32 of the grill portion 12 can result in a lighter part and thus decreased cost. Additionally, the utilization of a resist layer 70 can provide more consistent bonding between the grill portion 12 and the carrier portion 14. According to a further aspect, the use of a resist layer 70 may or may not be employed depending upon performance requirements. It will be appreciated that the metal layer 68 could also be removed from the rear side 32 of the grill portion 12 after plating to increase the adhesive characteristics.

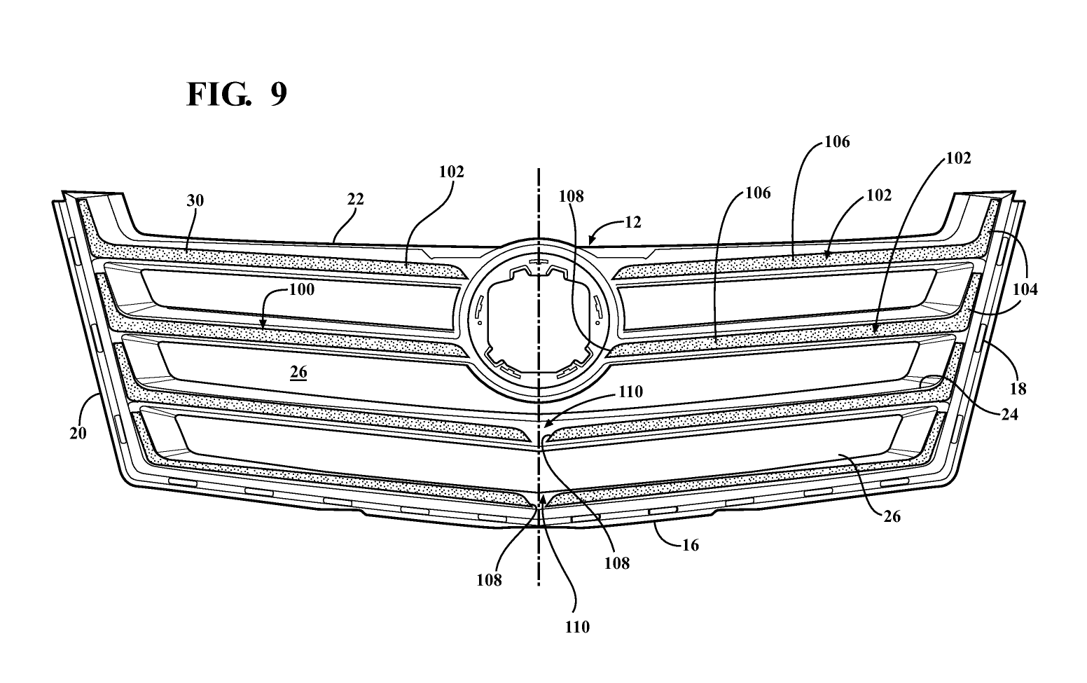

According to another aspect, the layer of adhesive 72 may be applied in a predetermined pattern, including for water management purposes. For example, with reference to FIG. 9, an exemplary adhesive pattern 100 is disclosed. As shown, the adhesive pattern 100 can consist of a plurality of ribbons 102 of adhesives disposed on predetermined portions of the carrier portion 14 or grill portion 12. According to an aspect, each ribbon 102 includes a short vertical portion 104 disposed adjacent one of the first side 18 or the second side 20. Each ribbon 102 also includes a horizontal portion 106 that is disposed on one of the generally horizontal cross-bars 24. As shown, each horizontal portion 106 extends along about ½ the length of the cross-bar. Each horizontal portion 106 includes an inner end 108 that is angled or tapered. According to an aspect, the inner ends 108 of the opposing horizontal portions 106 are slightly spaced apart from one another and have opposing angles. This configuration creates a slight funnel or drain 110 in the middle portion of the grill portion 12 between the opposing horizontal portions 106.

It will be appreciated that the layer of adhesive 72 may be applied to either to rear surface 32 of the grill portion 12 or the front side 40 of the carrier portion 14. It will further be appreciated that the adhesive layer 72 may be placed on the surfaces normal to vehicle travel and, according to an aspect, may be placed on the majority of mating surfaces between the grill portion 12 and the carrier portion 14 to provide increased sectional modulus, as discussed further herein. Utilizing the adhesive layer 72 on the surfaces normal to vehicle travel provides impact benefits as these are the surfaces most prone to sustaining impacts during vehicle use, such as from birds, stones, or the like. According to a further aspect, the use of an adhesive layer 72 can also be employed to facilitate attachment of other components to the grill assembly, including gimps, hardware, sensor housings, and any other components in a cost effective manner as it eliminates the need for separate attachment structures.

According to an aspect, it will be appreciated that the utilization of an adhesive to secure the grill portion 12 to the carrier portion 14 directly can create a laminate structure. The laminate structure resulting from these combined structures can maintain or improve the performance of the grill portion 12, including with respect to cold impact performance. The bonded attachment of the grill portion 12 to the carrier portion 14 can allow the structure of the carrier portion 14 to increase the strength and modulus of the assembly. According to an aspect, the laminate configuration can allow the thickness of the metal layer 68 to be reduced to provide material and cost savings. For example, as schematically shown in FIGS. 5A and 5B, the thickness of the grill portion 12 and the carrier portion 14 in prior art grill assemblies was known to be on the order of 3.5 mm in order to provide sufficient strength for each of these components. According to an aspect, the laminate structure of the grill assembly 10 allows the thickness of each of these parts to be reduced to 2.5 mm or less as desired. According to another aspect, the thickness of each of the grill portion 12 and/or the carrier portion 14 can each be reduced by greater or lesser amounts. Additionally, the parts could each have their thicknesses reduced by different amounts. Alternatively, the thickness of one of these structures could be reduced, while the other is increased or stays the same. According to another aspect, the thickness of these materials could be selected based on performance requirements. As will be appreciated, adhering two thinner parts can provide improved impact performance by dampening any impact so as to minimize damage to the grill assembly 10.

According to an aspect, the laminate construction of the grill assembly 10 can yield sound quality improvement via “thump/knock test” and/or firm feel displacement. Put another way, the grill assembly can feel sturdier and more substantial, which provides a perception of improved quality. According to another aspect, the laminate construction of the grill assembly 10 can improve fit and finish attributes as the required “overstroke” gaps/margins for snap-fit designs can be flush/net. Again, like with the “thump/knock test”, the removal of the gap by adhering the rear surface 32 of the grill portion 12 to the front side 40 of the carrier portion 14 can improve the quality perception. According to a further aspect, this precision manufacturing method of the grill assembly 10 allows for tighter, more eloquent, product designs.

According to another aspect, styling changes can easily be incorporated into the disclosed grill assembly 10 by adhesively attaching the grill portion 12 to the front side 40 of the carrier portion 14 to create a laminate construction. According to a further aspect, the laminate construction of the grill assembly 10 allows BSR as well as NVH issues to designed out by eliminating snap, heat stake and other mechanical attachments known to have a history of installation variation and in-field deterioration.

According to an aspect, the grill assembly 10 can yield a significant sectional modulus increase due to the laminate construction. As such, the unitary laminate grill assembly 10 can lead to mass reduction due to an increase in material thickness for the constituent parts. According to still another aspect, the unitary laminate grill assembly 10 can provide BSR improvement by serving as structural attachment point for other structures, such as headlamp claddings and supports, fog lamp bezels and supports, radiator supports, fascia claddings and supports, hood latch bracket support, and/or front end module. The laminate grill assembly 10 can obviously serve to support other structures.

According to a further aspect, due to the increased sectional modulus, the laminate grill assembly 10 can be configured such that the cross-bars 24 have a reduced height such that the plurality of openings 26 are enlarged. The increased opening size can allow for increased airflow to the cooling pack (radiator). Thus, increased air flow can be provided with a smaller, lighter grill assembly 10 that requires less space. According to a still further aspect, the sectional modulus increase can allow the grill assembly 10 to be smaller, which in turn provides for reduced packaging space for existing grill. This increased packaging space at the front end of the vehicle can be beneficial to accommodate the proliferation of electronic sensor and energy management packaging challenges. According to still a further aspect, the sectional modulus increase and decreased size of the grill assembly 10 can allow for utilization of active grill shutters without additional bracing or packaging space. It will be appreciated that instead of active grill shutters or electronic sensors, a variety of other suitable structures and/or features could benefit from the additional packaging space provided as a result of the disclosed laminate grill assembly 10.

According to still a further aspect, the increased sectional modulus of the grill assembly 10 can be used to drive impact zone performance of the front end module of the vehicle. Typical grills are not generally located in known impact zones. As such, energy management structures are generally contained in the rearward displacement or stroke of the bumper. According to an aspect, the carrier portion 14 could be constructed of a glass filled nylon material to provide benefits in impact zone performance. Similarly, the increased sectional modulus can be utilized to drive pedestrian protection performance of the front end module. Pedestrian protection is becoming an increasing important issue and the ability to address this through the grill assembly 10 can be very advantageous.

FIGS. 6A and 6B illustrate another aspect of the present disclosure. Specifically, FIG. 6A illustrates a cross-sectional view of prior art grill assembly 10′. The prior art grill assembly has a grill portion 12′ with a front surface 30′ that faces outward of the vehicle and a rear surface 32′ that faces inward in the direction of the engine compartment. As shown, the grill assembly 10′ includes a carrier portion 14′ having a front side 40′ and a rear side 42′. The carrier portion 14′ can be secured to the grill portion 12′ to form the assembly 10′ such that the front side 40′ of the carrier portion 14′ is spaced away from the rear surface 32′ of the grill portion 12′.

According to another aspect, FIG. 6B and FIG. 8 illustrates a grill assembly 10 in accordance with the present disclosure. As shown, the grill assembly 10 can include a grill portion 12 having a front surface 30 and a rear surface 32. The grill assembly 10 also includes a carrier portion 14 with a front side 40 and a rear side 42. The rear surface 32 of the grill portion may be bonded to the front side 40 of the carrier portion 14. According to an aspect, an adhesive layer 72 can be used to bond these structures with the adhesive placed on all net surfaces between these structures in order to provide a sufficient bond between them to form a laminate construction. The laminate construction yields significant benefits, including sectional modulus, as discussed above. According to an aspect, the thickness of each of the grill portion 12 and the carrier portion 14 may be reduced with respect to the grill portion 12′ and the carrier portion 14′ of the prior art. As discussed above, according to one example, the thickness can be reduced to 2.5 mm from a thickness previously of 3.5 mm. Again, as discussed above, the thickness of the parts can vary.

According to an aspect, a decorative metal layer 68 may be disposed on each of the front surface 30 and the rear surface 32 of the grill portion 12. According to a further aspect, the thickness of the metal layer 68 can be increased on each of the front surface 30 and the rear surface 32 to provide heavy plated surfaces to further increase the sectional modulus of the grill assembly 10. As is known, conventional metal plating thicknesses are in the range of 40 to 50 um. According to an aspect, the thickness of the metal plated layer 68 may be >50 um. By this configuration, the metal plated decorative grill can serve as a structural member. The added plating thickness on the front surface 30 and/or the back surface 32 of the grill portion can provide structural strength sufficient to offset or displace an adjoining bracket such as an underside existing grill opening reinforcement bracket and transfer some of the load to the grill assembly structure 10.

According to a still further aspect, some grill designs, such as those employing a floating grill bar, may require that the part locating features 80, 82 are built into the assembly nest These part locating features could assist the parts in self-locating. According to this technique, grill portion 12 would be located to nest 80 and the carrier portion 14 would be located to nest 82. Thereafter, the grill portion 12 is joined to the carrier portion 14 by locating nest 80 to nest 82.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. A grill assembly for attachment to a vehicle front end,
comprising:
an outer member having a front surface and a rear surface, the outer member including a peripheral border portion;
an inner member having a front side and a rear side, the inner member including an outer perimeter;
a decorative surface disposed on at least the front surface of the outer member;
wherein the rear surface of the outer member is bonded across substantially its entirety to the front side of the inner member so as to form a laminate grill structure.

2. The grill assembly of claim 1, wherein the outer member is a grill portion, which includes a plurality of generally horizontal grill cross-slats, which define a plurality of grill openings therebetween.

3. The grill assembly of claim 2, wherein the inner member is a carrier structure that includes a plurality of throughholes that generally align with the plurality of grill openings.

4. The grill assembly of claim 1, wherein the front side of the inner member is bonded to the rear surface of the outer member by an adhesive layer.

5. (canceled)

6. The grill assembly of claim 1, wherein the decorative surface is also disposed on the front side of the inner member.

7. The grill assembly of claim 6, wherein the decorative surface on the front side of the inner member results from a molded in color front side.

8. The grill assembly of claim 4, wherein the adhesive layer is applied to at least one of the outer member rear surface and the inner member front side in a predetermined pattern, said predetermined pattern forms at least one drain between spaced portions of the adhesive layer to provide improved water management capabilities.

9. The grill assembly of claim 2, wherein the decorative surface consists of a metal plated layer that is applied to at least the front surface of the grill portion.

10. The grill assembly of claim 9, further comprising:
a resist layer applied to the rear surface of the grill portion to prevent application of the metal plated layer thereon and further to promote adherence of the adhesive layer.

11. The grill assembly of claim 9, wherein the metal plated layer consists of one or more of the following metals: chromium, nickel, and copper.

12. The grill assembly of claim 4, wherein the decorative surface consists of a paint layer.

13. The grill assembly of claim 4, wherein the decorative surface results from a molded in color process.

14. The grill assembly of claim 9, further comprising a metal plated layer on the rear surface of the grill portion.

15. A grill assembly for attachment to a vehicle front end,
comprising:
an outer grill member having an outer surface and an inner surface, the outer grill member having a plurality of generally horizontal cross-bar portions defining a plurality openings;
an inner grill member having a front surface and a rear surface, the inner grill member having a plurality of holes that generally align with the plurality of openings in the outer grill member;
a decorative surface disposed on at least the outer surface of the outer grill member, the decorative surface on the outer grill member outer surface consisting of a metal layer;
an adhesive layer disposed between the inner surface of the outer grill member and the front surface of the inner grill member to securely bond the outer grill member and the inner grill member together.

16. The grill assembly of claim 15, wherein the adhesive layer is disposed in a predetermined pattern, said predetermined pattern forms at least one drain between spaced portions of the adhesive layer to affect water management.

17. (canceled)

18. The grill assembly of claim 16, wherein the decorative surface is also disposed on the front side of the inner grill member.

19. The grill assembly of claim 15, wherein the decorative surface on the front side of the inner grill member results from a molded in color front side.

20. The grill assembly of claim 15, wherein the metal layer is applied to the outer grill member by an electrolytic process.

21. The grill assembly of claim 20, further comprising:
a resist layer applied to the rear surface of the inner grill member to prevent application of the metal layer thereon and further to promote adherence of the adhesive layer.

22. The grill assembly of claim 20, wherein the metal layer consists of one or more of the following metals: chromium, nickel, and copper.

23. A laminate grill assembly for attachment to a vehicle front end, comprising:
an outer grill member having an outer surface and an inner surface, the outer grill member having a plurality of generally horizontal cross-bar portions defining a plurality openings;
an inner grill member having a front surface and a rear surface, the inner grill member having a plurality of holes that generally align with the plurality of openings in the outer grill member;
a decorative surface disposed on at least the outer surface of the outer grill member, the decorative surface on the outer grill member outer surface consisting of a metal plated layer;
an adhesive layer disposed between the inner surface of the outer grill member and the front surface of the inner grill member to securely bond the outer grill member and the inner grill member together; and
wherein the outer grill member has a thickness of 3 mm or less.

24. The grill assembly of claim 23, wherein the adhesive layer is disposed in a predetermined pattern, said predetermined pattern forms at least one drain between spaced portions of the adhesive layer to affect water management.

25. (canceled)

26. The grill assembly of claim 23, wherein the decorative surface is also disposed on the front side of the inner grill member.

27. The grill assembly of claim 26, wherein the decorative surface on the front side of the inner grill member results from a molded in color front side.

28. The grill assembly of claim 23, wherein the metal plated layer is applied to the outer grill member by an electrolytic process.

29. The grill assembly of claim 23, further comprising:
a resist layer applied to the rear surface of the inner grill member to prevent application of the metal plated layer thereon and further to promote adherence of the adhesive layer.

30. The grill assembly of claim 28, wherein the metal plated layer consists of one or more of the following metals: chromium, nickel, and copper.

31. The grill assembly of claim 23, wherein the decorative surface consists of a foil-insert molded film.
